(19) United States
(12) Patent Application Publication
(10) Pub. No.: US 2014/0306618 A1
(43) Pub. Date: Oct. 16, 2014

(54) WAVE-DRIVEN ELECTRONIC CANDLE

(71) Applicant: Derek Yang, HACIENDA HTS, CA (US)

(72) Inventor: Derek Yang, HACIENDA HTS, CA (US)

(21) Appl. No.: 13/860,532

(22) Filed: Apr. 11, 2013

(51) Int. Cl. H05B 33/08; F21V 33/00

(52) U.S. Cl. CPC H05B 33/0845; F21V 33/0028
USPC 315/291

(57) ABSTRACT

A wave-driven electronic candle includes an illuminator, a power supply for providing the necessary working voltage, a signal receiver, and a controller including a signal amplifier for amplifying a wave signal received by the signal receiver, a signal regulator for selecting a series or part of the waveform from the signal amplified by the signal amplifier, a filter for removing noises from the selected waveform, and an output amplifier for amplifying the filtered waveform signal for output to the illuminator to control the illuminator to flash.

### BACKGROUND OF THE INVENTION

(a) Field of the Invention

The present invention relates to electronic candles and more particularly to a wave-driven electronic candle, which uses a control circuit designed to receive a surrounding sound wave or radio wave signal for controlling an illuminator to flash.

(b) Description of the Prior Art

Conventional electronic candles commonly use a waveform generator to generate a predetermined waveform for controlling an illuminator to flash according to a predetermined flashing mode. Because the flashing mode is not variable, people will soon get bored looking at the candle. Due to one single flashing mode, conventional electronic candles have low viewability and are not attractive.

### SUMMARY OF THE INVENTION

The present invention has been accomplished under the circumstances in view. It is therefore the main object of the present invention to provide a wave-driven electronic candle, which comprises a power supply, an illuminator formed of at least one light-emitting diode and electrically connected to the power supply, a signal receiver for picking up an external wave signal, and a controller electrically connected in series between the signal receiver and the illuminator and electrically coupled with the power supply and adapted for receiving an input signal from the signal receiver and controlling the illuminator to give off light according to the input signal from the signal receiver. The controller comprises an input amplifier electrically connected to the signal receiver and adapted for amplifying the input signal, a signal regulator electrically connected to the input amplifier and adapted for picking up a waveform outputted from the input signal, a filter electrically connected to the signal regulator and adapted for removing noises from the waveform picked up by the signal regulator, and an output amplifier electrically connected in series between the filter and the illuminator for amplifying the filtered waveform outputted by the filter and outputting the amplified waveform to the illuminator to cause the illuminator to flash.

Further, the signal receiver comprises a sound receiver and/or a radio signal receiver.

Further, the signal regulator is adapted to pick up a series or part of the output waveform from the input signal.

Further, the filter is adapted to filter the amplitude and/or wavelength and/or frequency of the waveform received.

### BRIEF DESCRIPTION OF THE DRAWINGS

FIG. 1 is a circuit block diagram of a wave-driven electronic candle in accordance with the present invention.

### DETAILED DESCRIPTION OF THE PREFERRED EMBODIMENTS

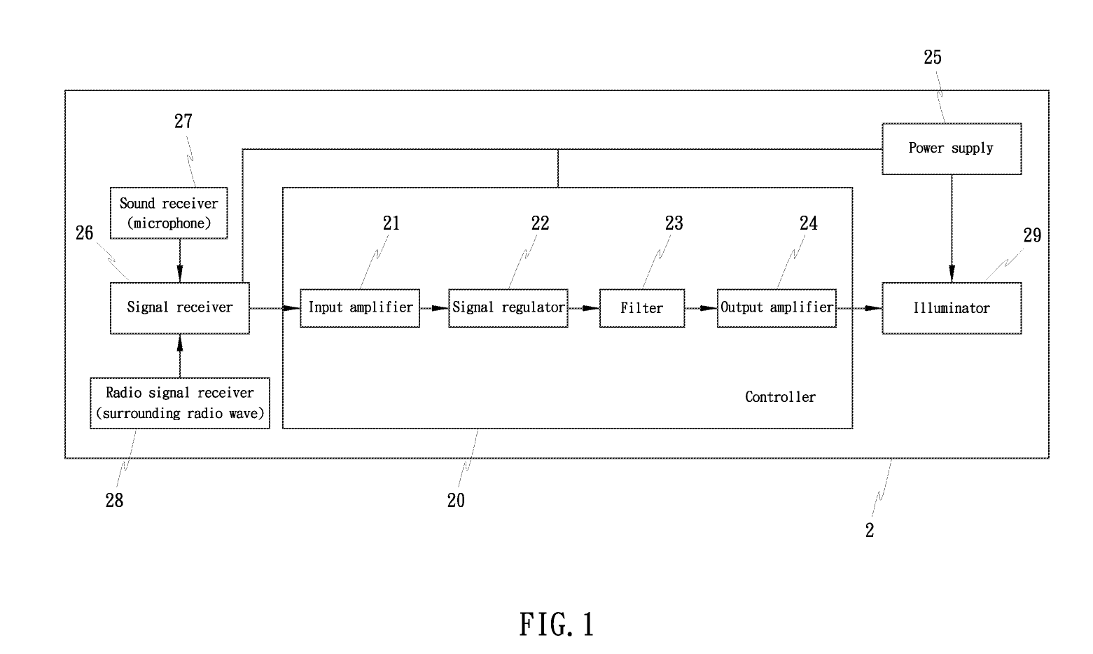

FIG. 1 shows a wave-driven electronic candle in accordance with the present invention. The wave-driven electronic candle 2 comprises an illuminator 29 formed of LEDs (light-emitting diodes), a power supply 25 electrically connected to the illuminator 29 to provide the illuminator 29 with the necessary working voltage, a signal receiver 26 that can be a sound receiver (microphone) 27 for converting a sound signal into an electrical signal and/or a radio signal receiver 28 for converting a radio signal into an electrical signal and is electrically connected to the power supply 25 to obtain the necessary working voltage, and a controller 20 electrically connected in series between the signal receiver 26 and the illuminator 29 for controlling the illuminator 29 to flash according to the sound signal or radio signal received by the signal receiver 26. The controller 20 is also electrically connected to the power supply 25 to obtain the necessary working voltage. Further, the controller 20 comprises an input amplifier 21 electrically connected to the signal receiver 26 for receiving a wave signal from the signal receiver 26 and amplifying the wave signal, a signal regulator 22 electrically connected to the input amplifier 21 for picking up a series or part of a waveform from the wave signal outputted by the input amplifier 21, a filter 23 electrically connected to the signal regulator 22 for filtering the amplitude and/or wavelength and/or frequency of the waveform outputted by the signal regulator 22, and an output amplifier 24 electrically connected in series between the filter 23 and the illuminator 29 and adapted for amplifying the filtered waveform signal outputted by the filter 23 and outputting the amplified waveform signal to the illuminator 29, driving the illuminator 29 to flash.

In conclusion, the invention picks up a surrounding sound wave or radio wave signal and processes the signal for controlling an illuminator to flash. The design of the wave-driven electronic candle in accordance with the present invention is more practical and more attractive and less tedious to the eyes.

What is claimed is:

1. A wave-driven electronic candle, comprising:
a power supply;
an illuminator formed of at least one light-emitting diode and electrically connected to said power supply;
a signal receiver for picking up an external signal; and
a controller electrically connected in series between said signal receiver and said illuminator and electrically coupled with said power supply and adapted for receiving an input signal from said signal receiver and controlling said illuminator to give off light according to said input signal from said signal receiver, said controller comprising an input amplifier electrically connected to said signal receiver and adapted for amplifying said input signal to output an amplified signal, a signal regulator electrically connected to said input amplifier and adapted for picking up a waveform of the amplified signal from said input amplifier, a filter electrically connected to said signal regulator and adapted for removing noises from the waveform picked up by said signal regulator, and an output amplifier electrically connected in series between said filter and said illuminator for amplifying the filtered waveform outputted by said filter and outputting the amplified waveform to said illuminator to cause said illuminator to flash.

2. The wave-driven electronic candle as claimed in claim 1, wherein said signal receiver comprises a sound receiver and/or a radio signal receiver.

3. The wave-driven electronic candle as claimed in claim 1, wherein said signal regulator is adapted to pick up a series or part of the waveform of the amplified signal from said input amplifier.

4. The wave-driven electronic candle as claimed in claim 1, wherein said filter is adapted to filter the amplitude and/or wavelength and/or frequency of the waveform picked up by said signal regulator.
